(19) United States
(12) Patent Application Publication
(10) Pub. No.: US 2005/0097335 A1
(43) Pub. Date: May 5, 2005

(54) Secure document access method and apparatus

(75) Inventors: Rajesh K. Shenoy, San Jose, CA (US); Charles A. Untulis, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/697,929

(22) Filed: Oct. 31, 2003

(51) Int. Cl. H04K 1/00; H04L 9/00

(52) U.S. Cl. 713/182

(57) ABSTRACT

A secure document access method and apparatus is described. The method includes the steps of capturing contents of a document and generating a key from a cryptographic engine. The method may also include encrypting the contents of the document using the key. The encrypted document may be stored and the key may be encoded. The encoded key may be submitted to at least one authorized user for accessing the contents of the encrypted document. The encryption may be performed by a multi-function peripheral.

### BACKGROUND

Securing contents of documents for confidentiality or privacy purposes is known in the art. Contents of these documents include text, graphics or a combination of both. Examples of such documents include medical records, tax records and legal records. Typically, access to these documents is limited to authorized users. A person's medical records may only be viewed by a physician for example.

Several techniques have been developed for achieving the desired security. Password protection is a simple form of restricting access. More complex forms include encryption of documents in which case authorized users typically use some form of decryption for accessing contents of documents. Contents of a document are scanned to produce a digital signal which is encrypted and coded as a two dimensional bar code that is affixed to the document as a label. The encryption uses a public key encryption system. In order to access the contents, the coded signal is scanned, decoded, decrypted, expanded and displayed. Other types of encoding used on documents include half tone patterns, image bar codes and micro ink.

In a secure printing method, a document is encrypted using a session key and a bulk encryption algorithm. The session key is encrypted using the recipient's public key. The encrypted session key, the encrypted document and the recipient's identity is transmitted to a print server. The recipient inserts a smart card at a secure printer for authentication. The encrypted document and the encrypted session key are transmitted to the secure printer upon authentication. The encryption session key is decrypted by the smart card and is used to decrypt the encrypted document for printing.

More recently, documents have been placed at a network location with an associated URL. Users typically obtain these documents by accessing the URL location via the internet for example.

Known methods include some form of encrypting and decrypting of contents of a document. The encrypted documents are usually transmitted to either the intended recipient or to a remote location such as the print server described above. In addition, a means of authorization for accessing the contents of the document are also transmitted to the intended recipient. The smart card described above is one method of authenticating the intended recipient.

Public key encryption systems are difficult to install and maintain. These systems are not easily scaleable if multiple recipients need access to a secure document. The entity securing the document needs knowledge of the public keys of all intended recipients. The document needs multiple encoding so that different recipients can decrypt the document. Public key systems also need a common root of trust for both the sender and recipient which is only possible if both entities obtain keys from the same source.

At least some embodiments provide improved methods and apparatus for securing and accessing contents of documents.

### SUMMARY

In one aspect, a method for accessing a secure document is described. The method includes the steps of capturing contents of a document and generating a key from a cryptographic engine. The method also includes encrypting the contents of the document using the key. The encrypted document may be stored and the key may be encoded. The encoded key may be submitted to at least one authorized user for accessing the contents of the encrypted document. The encryption may be performed by a multi-function peripheral.

In another aspect, a system for accessing a secure document is described. The system comprises means for capturing contents of a document, means for generating a cryptographic key, means for encrypting contents of the document, means for encoding said key, means for storing the encrypted document, means for communicating the encoded key to at least one authorized user and means for accessing the contents of the encrypted document utilizing said key by the at least one authorized user, wherein the contents of the encrypted document are encrypted by a multi-function peripheral.

In a further aspect, a multi-function peripheral is described. The peripheral comprises a scanner for capturing contents of a document, a cryptographic engine for generating a cryptographic key, at least one application specific integrated circuit (ASIC) programmed to encrypt contents of the document and to encode the cryptographic key, a memory device for storing contents of the document and a facsimile device for transmitting data.

### BRIEF DESCRIPTION OF THE DRAWINGS

The accompanying drawings, which are incorporated in and constitute a part of the specification, illustrate an embodiment of the invention and, together with the description, explain the invention. In the drawings,

FIG. 1 illustrates a system for accessing a secure document in accordance with an exemplary embodiment;

FIG. 2 illustrates a method in accordance with an exemplary embodiment of securing and accessing a document;

FIG. 3 illustrates a method for accessing a secure document;

FIG. 4 illustrates a multi-function peripheral for securing a document and for facilitating access to a secure document in accordance with an exemplary embodiment; and

FIG. 5 illustrates a method for securing a document in accordance with an exemplary embodiment.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

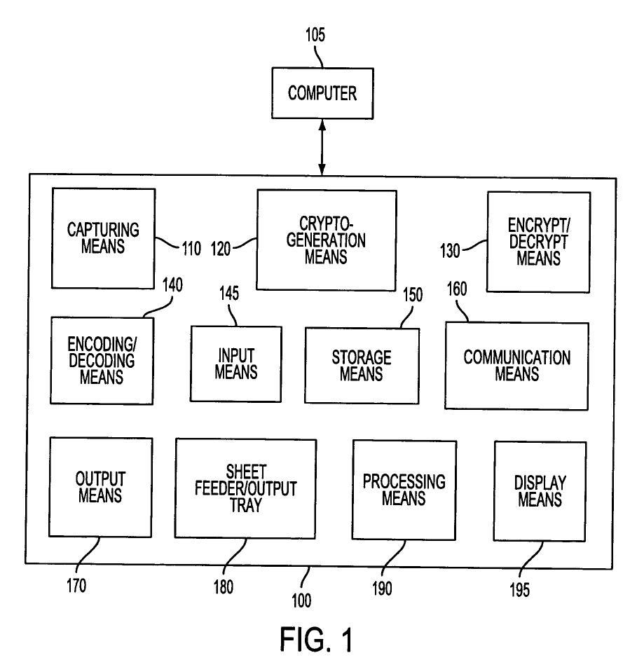

Referring to FIG. 1, a system 100 configured to access a secure document is shown in accordance with one embodiment. The system 100 may be a multi-function peripheral (MFP) that may be connected to a computer 105.

A multi-function peripheral is a single device that combines several functions. Typically, MFPs are capable of copying, scanning, printing and faxing of documents. Printing may be performed by commands from a computer while copying may be performed by user interaction. Scanning and faxing may be performed either by commands from a computer or via user interaction.

System 100 of FIG. 1 includes a means 110 for capturing contents of a document. The capturing means 110 maybe a scanner for example. The document may include text, graphics or a combination of both. The contents of the document may be captured by scanning or as a digital image. In order to capture contents of a physical document, the document may be input to the system 100 via a feeding tray 180 or other similar means. The document may also be in an electronic format in which case the contents of the document maybe saved in storage means 150. A document in electronic form may be received (by the system 100) from a computer 105 or from another system.

System 100 also includes a crypto-generation means 120 and an encrypt/decrypt means 130. Crypto-generation means 120 maybe a cryptographic engine for generating a cryptographic key. The key may be generated based on one or more variables such as the time of day for example. Other variables may include an identifier corresponding to the system, an optional word or phrase input by a user or some other attribute obtained from the document. The key may be specific to a particular document. The key need not be specific to a particular sender. The contents of the document may be encrypted by the encrypt/decrypt means 130 using the cryptographic key.

Exemplary system 100 further includes an encoding/decoding means 140 for encoding the cryptographic key into a secure form such as a bar code. System 100 includes storage means 150 which may be used to store the encrypted document or to store documents in received from computer 105 in electronic form. A communication means 160 facilitates communication and output means 170 may be used for outputting contents of a document. A processing means 190 controls and enables the various functions performed by the system 100 and a display means 195 displays various items. These items may include contents of a document or instructions on how to use system 100. Interaction with system 100 may be achieved via the display means 195 or input means 145. Input means 145 may be a keypad or a mouse for example.

The encoding/decoding means 140 may be used to encode the key as well as to decode the encoded key. The key may be encoded as a bar code, a watermark on paper, a half-tone image pattern or a type of invisible ink. The storage means 150 may be a hard drive or other similar storage device. The communication means 160 may be a facsimile machine for example and capable of transmitting to another similar system or other computers. The encoded key may be in the form of a bar code printed on paper or other physical media the contents of which may be decoded. The encoded key may be transmitted using the communication means 160 to intended recipients.

The output means 170 maybe a printer for example. Output means 170 may be used to output the encoded key if the encoded key is not on paper. The encoded key may then be used by an intended recipient, also referred to as an authorized user, to obtain access to the secure document. The encode/decode means 140 may decode the key and the encrypt/decrypt means 130 may decrypt contents of the document using the decoded key.

Instructions from a computer 105 connected to system 100 may instruct the system 100 to encrypt the contents of a document sent from the computer 105. Computer 105 may also instruct system 100 to communicate with another system via the communication means 160. The communication means 160 may be capable of transmitting to other systems.

The crypto-generation means 120, the encrypt/decrypt means 130 and the encode/decode means 140 may be integrated within the system 100 or be external, and connected, to system 100.

The encoded key may be shared by more than one user. The encoded key may specify the number of times a particular document may be accessed or output via a printer. If the number of times is specified, a counter may be utilized to indicate this number as well as the number of remaining times the document can be accessed. A time limit may also be specified to indicate an expiration date beyond which the document may not be accessed or output.

System 100 of FIG. 1 facilitates the encryption, decryption, encoding and decoding functions. The cryptographic function may be realized either through a software process or via hardware such as an application specific integrated circuit (ASIC). Similarly, decryption, encoding and decoding may be achieved via a software process or through the ASIC. A single ASIC may perform some or all of the functions. A combination of one or more ASICs and one or more software processes may also perform the various functions. System 100 may also be made tamper proof such that all keys within the system may be destroyed if tampering occurs.

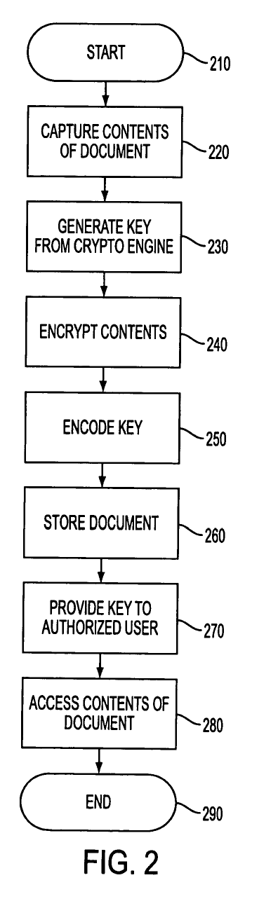

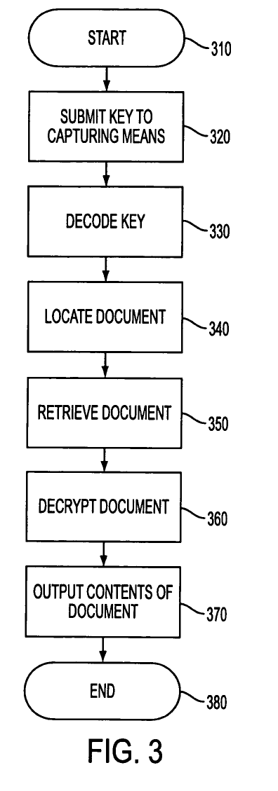

An exemplary method of accessing a secure document may be described with reference to FIGS. 2 and 3.

Referring to FIG. 2, an exemplary method for accessing a secure document is shown. The method commences at step 210. The contents of a document may be captured in step 220. Contents of a document may include text and graphics such as figures, photos and charts. The contents may be captured either by scanning or as a digital image. The contents of a document in electronic format may be stored in electronic format on a storage medium.

In step 230, a cryptographic key may be generated based on one or more variables such as time of day for example. The key may be generated from a cryptographic engine. In step 240, the key may be used to encrypt the contents of the document. The key may be encoded in step 250 as a bar code or other types of code. The encrypted document may be stored in step 260. The encrypted document may be stored locally (i.e., where the contents of the document were captured) or at an authorized user's location.

The encoded key may be transmitted to an authorized user at step 270. This may be accomplished either electronically via electronic mail for example, or by physical transfer. The key may be represented by a bar code or other type of code and may be printed and forwarded to the intended recipient via a physical transfer such as being handed over or delivered by a courier or by some other form of secure delivery (register mail for example) to the intended recipient. The recipient may print out the electronic version of the encoded key represented by the code.

The intended recipient may utilize the encoded key to access the document at step 280 and the process ends in step 290.

The access method in step 280 of FIG. 2 is described in further detail with reference to FIG. 3. The method commences in step 310. An intended recipient (or authorized user) may submit the encoded key at step 320 to capturing means 110 of FIG. 1. The key maybe represented by a bar code on paper or on another type of physical media. The contents of the key may be captured at step 320 and decoded at step 330. The decoded key may be used to identify and locate the document that corresponds to the key at step 340. The document may then be retrieved at step 350 and decrypted at step 360. Upon decryption, the contents of the document may be output at step 370 and the process ends at step 380.

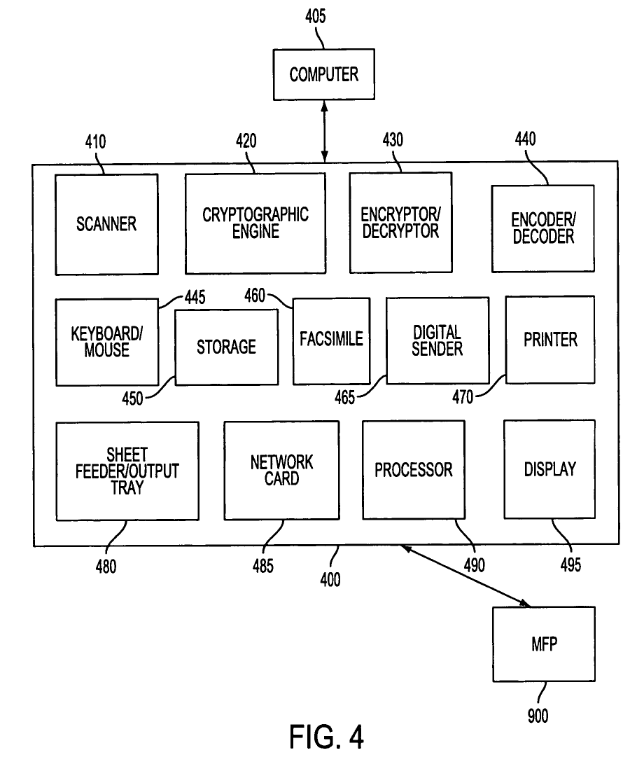

A multi-function peripheral (MFP) in accordance with an exemplary embodiment is illustrated in FIG. 4. MFP 400 may include a scanner 410 for capturing contents of a document. A cryptographic engine 420, implemented either as a software process or as an application-specific integrated circuit (ASIC), may generate cryptographic keys that may be used for encryption. An encryptor/decryptor 430, implemented as an ASIC or as a software process, may encrypt contents of a document. It may also decrypt the contents of an encrypted document. An encoder/decoder 440, also in software or hardware form, may encode the key generated by the cryptographic engine. It may also decode the encoded key.

Scanner 410 may scan contents of a document line by line and encrypt the contents on this basis (i.e., line by line) in exemplary embodiments. Scanner 410 can also scan contents of an entire document prior to encrypting the contents.

A user may interact with MFP 400 via user interface 445. User interface 445 may be a keyboard, a mouse or a track pad for example. MFP 400 includes storage 450, a processor 490 and a display 495 which may provide instructions on usage or status of the MFP or may display contents of documents. A sheet feeder 480 and an output tray 485 may be used for handling paper.

The multi-function peripheral 400 of FIG. 4 may also include a facsimile 460, a digital sender unit 465 and a printer 470. The digital sender unit 465 may submit the encoded key electronically to a recipient either at a computer or at another MFP. The recipient may receive the key from the digital sender at an e-mail address. MFP 400 may be connected to a computer 405 or to another MFP 900 over a network using a network card 465. The network may be a secure network if the encoded key is sent from one MFP (such as MFP 400) to another MFP (such as MFP 900). If MFP 900 in the illustrated example does not receive the encoded key from MFP 400, then the network may be secure but need not be so.

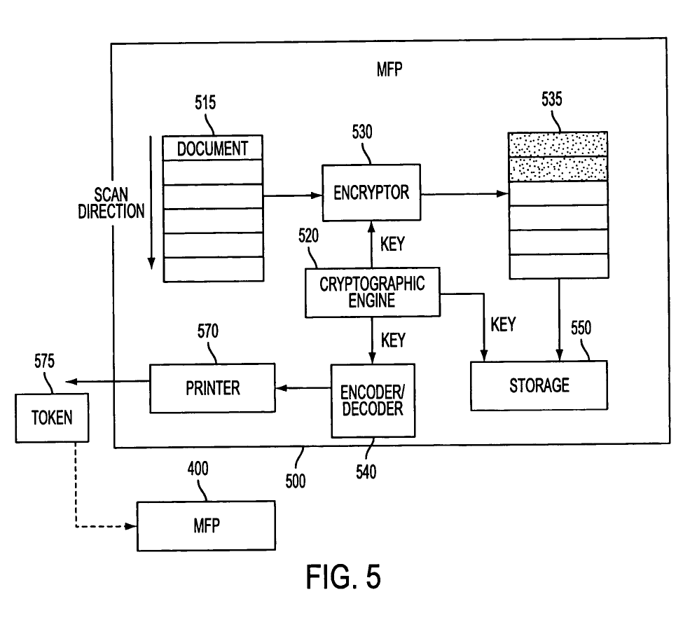

In an exemplary embodiment, with reference to FIG. 5, contents of a document 515 may be captured line by line and encrypted by encryptor 530 line by line in MFP 500. As described, a cryptographic engine 520 may generate a key for encrypting the contents of document 515. The generated key may be used to encrypt the contents of the document line by line. The scanning of a second line may take place while the contents of the first line are being encrypted. An encrypted document 535 may be generated in this manner as illustrated. The encrypted document may be placed in storage 550 and the key used for encrypting the document may be encoded by encoder/decoder 540. The encoded key may then be printed by printer 570 and output as a token 575. Token 575 may then be presented to MFP 400 for decoding and subsequently for decrypting the document 535 into unencrypted document 515

The method and apparatus described above may be scaleable if multiple recipients require access to a secure document. The encrypting entity does not need knowledge of the public keys of all intended recipients since public key encryption is not used. A document may be encoded once and yet provide access to different, multiple recipients. An encoded key may act as a token of trust between the entity encrypting the document and the one or more recipients that may access the document using the encoded key.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. For example, some of the functionality of system 100 may be incorporated into a presentation means such as a projector connected to a computer. The projector may display images received from a computer and then encrypt the images for later retrieval by authorized users.

The following claims and their equivalents define the scope of the invention.

1. A secure document access method comprising:
capturing contents of a document;
generating a key from a cryptographic engine;
encrypting the contents of the document using said key by a multi-function peripheral;
encoding the key;
storing said encrypted document;
communicating the encoded key to at least one authorized user; and
accessing the contents of the encrypted document utilizing said key by the at least one authorized user.

2. The method of claim 1, wherein the encoded key is transmitted to the at least one authorized user in an electronic form.

3. The method of claim 1, wherein the encoded key is represented by a half-tone pattern.

4. The method of claim 2, wherein the encoded key is output via a printer.

5. The method of claim 2, wherein the encoded key is transferred to the at least one authorized user in a secure manner.

6. The method of claim 1, wherein the cryptographic key is generated via a software process.

7. The method of claim 1, wherein the encryption specifies a maximum number of times the encrypted document is to be accessed.

8. The method of claim 7, wherein a remaining number of times the document is available for output is indicated.

9. The method of claim 1, wherein the encryption specifies a time by which the encrypted document is to be accessed.

10. The method of claim 1, wherein a first multi-function peripheral captures the contents of the document and the authorized user accesses the document at a second multi-function peripheral.

11. The method of claim 1, wherein said accessing of the encrypted document comprises the steps of:
decoding said encoded key;
locating the encrypted document;
retrieving the encrypted document;
decrypting the contents of the encrypted document; and
outputting contents of the document.

12. The method of claim 1, wherein contents of the document are captured line by line.

13. A system for accessing a secure document comprising:
means for capturing contents of a document;
means for generating a cryptographic key;
means for encrypting contents of the document;
means for encoding said key;
means for storing the encrypted document;
means for communicating the encoded key to at least one authorized user; and
means for accessing the contents of the encrypted document utilizing said key by the at least one authorized user, wherein the contents of the encrypted document are encrypted by a multi-function peripheral.

14. A multi-function peripheral comprising:
a scanner for capturing contents of a document;
a cryptographic engine for generating a cryptographic key;
at least one application specific integrated circuit (ASIC) programmed to encrypt contents of the document and to encode the cryptographic key;
a memory device for storing contents of the document; and
a facsimile device for transmitting data.

15. The multi-function peripheral of claim 14 further comprising:
a digital sender unit for submitting the encoded key to a recipient in an electronic manner.

16. The multi-function peripheral of claim 14 further comprising:
a network card for communicating with another multi-function peripheral over a network.

17. The multi-function peripheral of claim 16 wherein the network is a secure network.

18. The multi-function peripheral of claim 14, wherein said cryptographic engine is another application specific integrated circuit (ASIC).

19. The multi-function peripheral of claim 14, wherein said cryptographic engine is a software process.

20. The multi-function peripheral of claim 14, wherein said at least one ASIC is programmed to decode the encoded key and to decrypt the encrypted document.

21. The multi-function peripheral of claim 14 further comprising:
a printer for outputting the key in the encoded form.

22. The multi-function peripheral of claim 14, wherein the at least one ASIC is programmed to generate the cryptographic key.

23. The multi-function peripheral of claim 14, wherein the facsimile machine transmits the key in the encoded form.

24. A machine readable medium comprising a computer program for causing a computer to:
create a document;
submit the document to a peripheral having a cryptographic engine; and
instruct the peripheral to encrypt contents of the document, said instructions further causing the peripheral to:
generate a key from the cryptographic engine;
encrypt contents of the document using said key;
store the encrypted document;
encode the key; and
transmit the key to at least one authorized user for accessing the encrypted document.
